(19) United States
(12) Patent Application Publication
(10) Pub. No.: US 2002/0172928 A1
(43) Pub. Date: Nov. 21, 2002

(54) Polyhedral model with pyramidal elements

(76) Inventor: Michael F. Suchta, Sacramento, CA (US)

Correspondence Address: DAVIS & ASSOCIATES, P.O. BOX 1093, DRIPPING SPRINGS, TX, 78620, US

(21) Appl. No.: 09/862,455

(22) Filed: May 21, 2001

(51) Int. Cl. G09B 23/02; G09B 23/04

(52) U.S. Cl. 434/211

(57) ABSTRACT

An polytope model includes a plurality of polyhedral elements, each element having a plurality of slanted faces and a base. The slanted faces meet at a common apex. For example, the polyhedral elements may be n-gon pyramids. In one embodiment, the polyhedral elements are identical. In alternative embodiments, the elements may define multiple distinct polyhedrons. The polyhedral elements are arranged such that the slanted faces of each element are disposed adjacent the slanted faces of other elements. The bases of the arranged polyhedral elements form the facets of a formed polyhedron. In one embodiment, the polyhedral elements are square pyramids such that the formed polyhedron is a cube wherein the faces of the cube are the bases of the square pyramids.

### FIELD OF THE INVENTION

This invention relates to the field of solid geometry. In particular, this invention is drawn to modeling polytopes.

### BACKGROUND OF THE INVENTION

A polyhedron is a 3 dimensional geometric solid consisting of a collection of polygons joined at their edges. Polyhedrons represent a subset of polytopes which can be generalized to an n-D entity, where “n-D” refers to n dimensional. A 4-D hypercube, for example, is a measure polytope with mutually perpendicular sides (i.e., an orthotope).

Hypercubes and other polytopes serve as mathematical analysis tools. For n≦3, n-D polytopes are generally easily rendered and visualized. For n>3, polytopes are considerably more difficult to visualize. Although higher order polytopes may be studied analytically, the limited ability to visualize these objects tends to inhibit analysis.

### SUMMARY OF THE INVENTION

An apparatus includes a plurality of polyhedral elements, each element having a plurality of slanted faces and a base. The slanted faces meet at a common apex. In one embodiment, the polyhedral elements are identical. In alternative embodiments, the elements may define multiple distinct polyhedrons. The elements are arranged such that the slanted faces of each element are disposed adjacent the slanted faces of other elements. The bases of the arranged polyhedral elements form the facets of a formed polyhedron. The polyhedral elements may be n-gon pyramids. In one embodiment, the polyhedral elements are square pyramids such that the formed polyhedron is a cube wherein the faces of the cube are the bases of the square pyramids.

A frame may be used to support the formed polyhedron. In various embodiments, the frame is an external self-supporting frame or a frame such as an adhesive tape that holds the model together by securing the polyhedral elements to each other.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 illustrates a method for assembling a polyhedron model from a plurality of pyramidal polyhedral elements.

FIG. 2 illustrates method and apparatus for framing the polyhedron model of FIG. 2.

### DETAILED DESCRIPTION

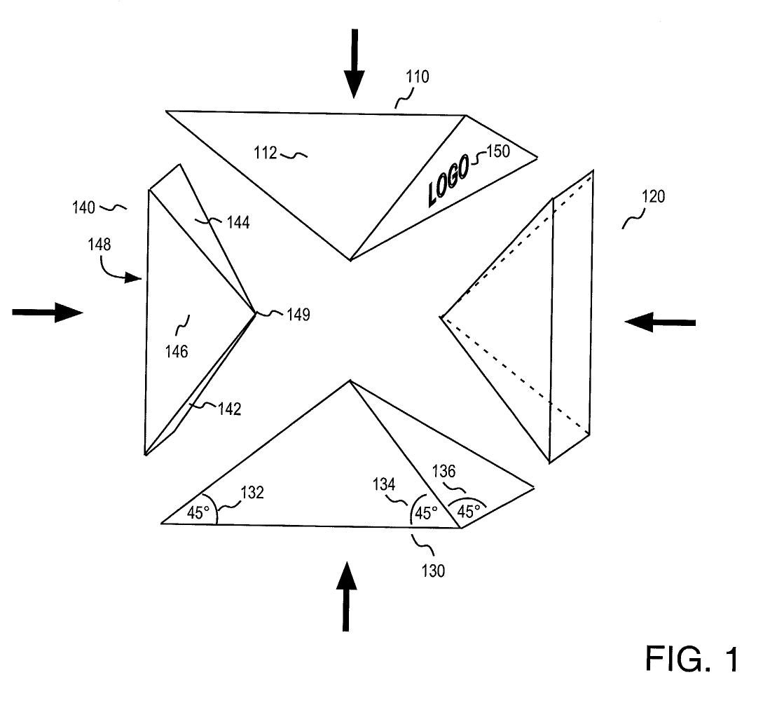

FIG. 1 illustrates an apparatus for modeling an n-D polytope. In one embodiment, the apparatus comprises a plurality of polyhedral elements 110, 120, 130, and 140. The polyhedral elements are pyramidal. In particular, each element has a base 148 and a plurality of triangular slanted faces or sides 112, 142, 144, 146 converging at an apex 149. In one embodiment, the elements are square pyramidal polyhedrons as determined by the shape of the base.

The polyhedral model is assembled by positioning the slanted faces of each polyhedral element adjacent the slanted face of another polyhedral element. In one embodiment, each base angle (i.e., the angle 132, 134, 136 at which the sides 112, 142, 144, 146, etc. slant away from the base of the square pyramid is 45°. Thus the sides (e.g., 144, 146) of each pyramid correspond to isosceles triangles.

The polyhedral elements of FIG. 1 are assembled to form another polyhedron. In particular, the bases of the polyhedral elements 110-140 form the faces of a cube when assembled. Although a cube has 6 faces and would require 6 square pyramidal polyhedral elements, only 4 are illustrates so as not to obscure the method of assembling the formed polyhedron. A design or etching 150 may be located on one or more of the sides of one or more pyramidal elements to create interesting optical effects.

In one embodiment, the top, bottom, and slanted faces of the pyramids are polished to enhance the optical effect of the assembled polyhedral model. Each polyhedral element should have substantially a same index of refraction throughout so as to avoid any 3-D wireframe effect. Thus the polyhedral elements should be solid throughout. In one embodiment, the polyhedral elements have substantially the same index of refraction. Exemplary materials for construction of these components due to their index of refraction include acrylic, glass, or crystal. The polyhedral elements may be clear and substantially colorless. Alternatively, the components may have varied coloration.

The polyhedral model may be assembled with the use of adhesives or a frame or a combination of the two. In one embodiment, adhesives are applied to the slanted faces (144, 146, 112, etc.) of the polyhedral elements. Any adhesive applied in this manner should be selected so as not to optically mar the surfaces. In addition, the adhesive selected should be substantially transparent to avoid introducing optical occlusion. Pressure may be applied orthogonal to the bases of all the polyhedral elements to evacuate bubbles that may otherwise be introduced by the adhesive.

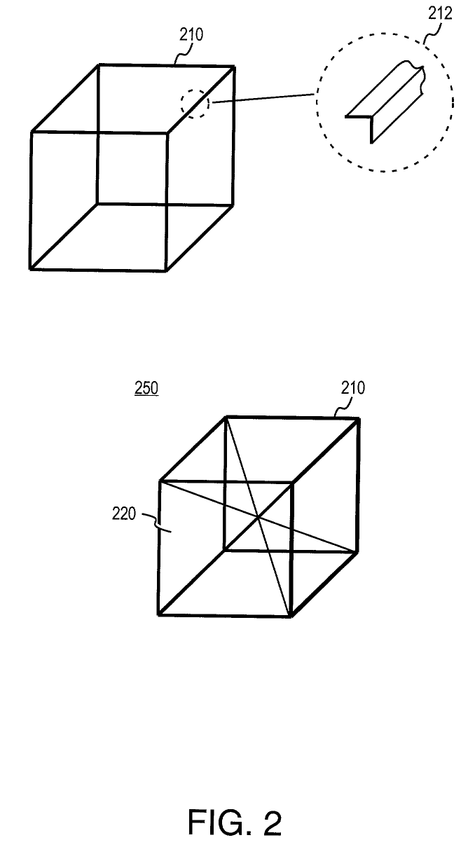

FIG. 2 illustrates a framed polyhedral model 250. Framed model 250 includes frame 210 for supporting the polyhedron model 220. In one embodiment, frame 210 is an external self-supporting frame comprising a plurality of members having an L-shaped cross-section as indicated in expanded view 212. Alternatively, a frame may be formed using an adhesive tape at the vertices to secure the polyhedral elements to each other. In one embodiment, the adhesive tape is placed along the edges of the polyhedral elements resulting in a cross-section profile as illustrated in expanded view 212.

Polyhedral models other than cubes may be formed by using polyhedral elements other than square pyramids. Moreover, the plurality of polyhedral elements may consist of distinct polyhedral shapes instead of the same polyhedral shape. In one embodiment, a polyhedral model is formed from a plurality of pyramids, wherein each pyramid has an n-gon base. The n-gon base refers to a polygon with n sides. For example, the base may be a trigon (i.e., triangle), tetragon (e.g., square), pentagon, hexagon, heptagon, octagon, nonagon, decagon, or higher n polygon. In various embodiments, the n-gon base corresponds to regular polygons, i.e., polygons with sides having the same length. The polyhedral elements are generally convex pyramidal polyhedrons that are assembled to form a 3-D polytope in the form of another convex polyhedron.

The assembled polyhedral model may be used for studying higher dimensional polytopes. Due to the nature of the internally refracting surfaces of the polyhedral elements, the assembled polyhedral model has visually intriguing optical properties suitable. These properties make the assembled polyhedral model a suitable paperweight, advertising display (e.g., commercial, academic, or sports-related advertising), conversation piece, or simple curiosity.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. An apparatus comprising:
a plurality of polyhedral elements, each element having a base and a plurality of slanted faces converging at an apex, wherein the slanted faces of the elements are disposed adjacent to each other such that the bases form the facets of a formed polyhedron.

2. The apparatus of claim 1 wherein the polyhedral elements are n-gon pyramids.

3. The apparatus of claim 1 wherein the formed polyhedron is a cube, wherein the facets correspond to faces of the cube.

4. The apparatus of claim 3 wherein the elements are square pyramids, wherein the bases of the square pyramids form the faces of the cube.

5. The apparatus of claim 1 wherein each of the plurality of elements has approximately a same index of refraction throughout.

6. The apparatus of claim 1 further comprising:
a frame surrounding the elements.

7. The apparatus of claim 5 wherein the frame is a self-supporting external frame.

8. The apparatus of claim 5 wherein the frame secures each element to an adjacent element.

9. The apparatus of claim 1 wherein the formed polyhedron model has substantially a constant index of refraction throughout.

10. The apparatus of claim 1 wherein the polyhedral elements are substantially identical.

11. The apparatus of claim 1 wherein the polyhedral elements define distinct polyhedrons.

12. The apparatus of claim 1 wherein at least one slanted face of one element further comprises a logo.

13. The apparatus of claim 1 wherein a selected base of a selected polyhedral element is one of a trigon, tetragon, pentagon, hexagon, heptagon, octagon, nonagon, decagon.

14. The apparatus of claim 1 wherein the base of at least one polyhedral element is a regular polygon.

15. A method comprising the steps of:
providing a plurality of polyhedral elements each having a base and a plurality of slanted faces converging at an apex; and
assembling the elements such that a selected slanted face of each element is disposed adjacent a selected slanted face of another element of the plurality of elements to form an assembled polyhedron.

16. The method of claim 15 wherein each polyhedral element is an n-gon pyramid.

17. The method of claim 16 wherein each polyhedral element is a square pyramid, wherein the assembled polyhedron is a cube, wherein the base of each polyhedral element forms one face of the cube.

18. The method of claim 12 wherein the plurality of polyhedral elements themselves define a plurality of distinct polyhedrons.

19. The method of claim 12 wherein the assembled polyhedron has substantially a same index of refraction throughout.

20. The method of claim 15 further comprising the step of:
framing the assembled polyhedron to maintain the positions of the polyhedral elements relative to each other.
